(19) United States
(12) Patent Application Publication
(10) Pub. No.: US 2015/0008663 A1
(43) Pub. Date: Jan. 8, 2015

(54) CLAMPING DEVICE COMPRISING A COLLAR AND A SLEEVE

(71) Applicant: ETABLISSEMENTS CAILLAU, Issy Les Moulineaux (FR)

(72) Inventors: Stéphane DRIVON, Romorantin (FR); Fabrice PREVOT, Selles Sur Cher (FR); Nicolas RIGOLLET, Romorantin (FR)

(21) Appl. No.: 14/322,709

(22) Filed: Jul. 2, 2014

(30) Foreign Application Priority Data
Jul. 3, 2013 (FR) 1356494

(51) Int. Cl. F16L 57/00; F16L 23/08

(52) U.S. Cl. CPC F16L 57/00; F16L 23/08
USPC 285/45

(57) ABSTRACT

The clamping device comprises a clamping collar (10) having a belt (12) that is suitable for being tightened. The device further comprises an outer sleeve (16) carried by the collar (10) while being disposed around the belt, the sleeve extending axially on either side of the belt.

### CROSS-REFERENCE TO RELATED APPLICATIONS

This application claims priority under 35 U.S.C. §119 to French Patent Application No. 1356494, filed Jul. 3, 2013, which is incorporated herein by reference in its entirety.

### BACKGROUND

The present invention relates to a clamping device comprising a clamping collar having a belt that is suitable for being tightened.

Devices of that type are known in which the belt serves to interconnect two articles by clamping them one onto the other or one against the other. For example, the articles may be constituted by a tube and by an end-piece onto which the tube is engaged in interfitting manner, or indeed they may be constituted by tubes disposed end-to-end, the contact ends of which are flared so as to be received in a recess formed around the inside periphery of the belt of the collar.

For example, Documents EP 1 451 498 and U.S. Pat. No. 3,964,773 disclose devices used for interconnecting such tubes disposed end-to-end.

The articles clamped using the clamping device can be subjected to relatively high temperatures. In particular, the articles may be constituted by two tubes engaged in interfitting manner one on the other, or disposed end-to-end, and through which fluid at a high temperature can flow, e.g. exhaust-pipe tubes for an internal combustion engine, in particular of the type used in vehicles.

In such a situation, it is often desired to limit transmission of heat towards the outside. It is sought to avoid the outside wall of the clamped articles being burning hot, which could render any contact with that wall dangerous.

For that purpose, the articles that the device serves to interconnect may be clad with a thermal protection sheath. However, in the region in which the clamping device is situated, the sheath is interrupted in order to enable the clamping to take place in that region. It might be imagined that another sheath could be placed around the clamping device once it has been tightened, but that would hinder both disassembly and also readjusting the clamping. Therefore, although it is possible to limit heat transmission over almost the entire length of the articles interconnected by means of the device, such heat transmission limitation is not possible in the region in which the clamping device is situated.

An object of the invention is to propose a clamping device that remedies the above-mentioned drawbacks, at least to a significant extent.

This object is achieved by the fact that the device further comprises an outer sleeve carried by the collar while being disposed around the belt, said sleeve extending axially on either side of the belt.

Thus, the sleeve acts as a local protective sleeve, in the region of which the collar is situated, but it projects axially on either side of the belt, so that it can easily come to overlap sheaths or the like, disposed over the interconnected articles, so as to provide thermal protection, i.e. so as to limit transmission of heat to the outside. The sleeve forms a sort of bridge over the interruption in the thermal protection, in the clamping or interconnection zone, in which the clamping device is disposed. Thus, the clamping is achieved by the belt, which is of limited axial dimension (corresponding to the width of the belt). As a result, the interconnected articles can be covered with a protective sheath that is interrupted over only a limited axial length, just before and just after the belt (e.g. just before the flares in the tubes formed at their respective free ends). However, the sleeve that is carried by the collar extends axially on either side of the belt and thus comes to overlap the protective sheath or the like, thereby actually enabling continuity to be provided for the thermal protection.

In an embodiment, clearance exists between the outside periphery of the belt and the inside periphery of the sleeve.

When the device clamps an article, the belt is directly in contact with said article. Thus, since the thermal protection is interrupted in the region of the belt, then if the article is hot, the heat from the article is transmitted by conduction to the belt. By making provision for clearance to exist between the outside periphery of the belt and the inside periphery of the sleeve, it is possible to avoid transmission of heat by conduction throughout the zone in which the clearance exists.

As explained below, the sleeve may be fastened to the collar, e.g. via the belt thereof. Provision is then made for the above-mentioned clearance to exist over all of the facing surfaces of the belt and of the sleeve, except for the fastening zones, which are then of small dimensions. The heat transmission by conduction is then extremely low.

It is also noted that the above-mentioned clearance makes it possible to avoid vibratory contact between the belt and the sleeve, and thus eliminates vibration noise, which is particularly advantageous when the clamping device serves to interconnect exhaust-pipe tubes for a vehicle engine.

In an embodiment, the width of the sleeve, as measured along the axis A of the belt, is at least equal to three times the width of the belt.

In the direction of the axis of the belt, the sleeve thus projects on either side thereof, over a length that is, in general, sufficient to provide axial continuity with a thermal protection sheath disposed around the interconnected articles.

In an embodiment, the sleeve is fastened to the collar at at least two spaced-apart fastening zones.

The fastening can thus be achieved simply, without adversely affecting the quality of the clamping, because, by choosing fastening zones that are spaced apart, it is possible to avoid over-stiffening the contact between the sleeve and the clamping collar. In addition, as indicated above, choosing fastening zones that are spaced apart makes it possible to provide clearance between the outside periphery of the belt and the inside periphery of the sleeve over their entire facing surfaces, except for the fastening zones.

In an embodiment, the sleeve is provided with projections that project from the inside face of the sleeve and that co-operate with the belt.

It may be chosen that at least some of the projections serve as fastening zones.

These projections may thus serve as spacers and also be used for fastening.

In another embodiment, the sleeve is fastened to the belt by welding or by clinching.

In an embodiment, the sleeve has fastening tabs suitable for co-operating with the collar.

In an embodiment, the sleeve co-operates with the collar by clipping, snap-fitting or latching.

The collar and the sleeve may then be manufactured separately and be assembled at will.

In an embodiment, the collar has tightening lugs that are suitable for being brought towards each other by tightening means, and the sleeve is carried by the collar via at least one of the elements constituted by the tightening lugs and by the tightening means.

In an embodiment, the collar is provided with tightening lugs projecting radially relative to the belt, and the sleeve is provided with a window through and beyond which the tightening lugs project.

Thus, the sleeve also extends in the region of the tightening lugs, laterally (i.e. in the axial direction of the belt) on either side of said lugs. The presence of the window thus makes it possible to preserve access to the tightening lugs so as to tighten the collar, but the marginal strips of the sleeve situated on either side of the window continue act to provide protection as does the remainder of the sleeve.

One possibility is then for the sleeve to have a first end situated in the vicinity of the first tightening lug and a second end that is provided with the window and that has its free end co-operating with the first end.

Thus, the sleeve is looped over more than one turn, and offers effective protection that is interrupted only in the region of the window through and beyond which the tightening lugs project.

### DETAILED DESCRIPTION

The invention can be well understood and its advantages appear more clearly on reading the following detailed description of embodiments shown by way of non-limiting example. The description refers to the accompanying drawings, in which:

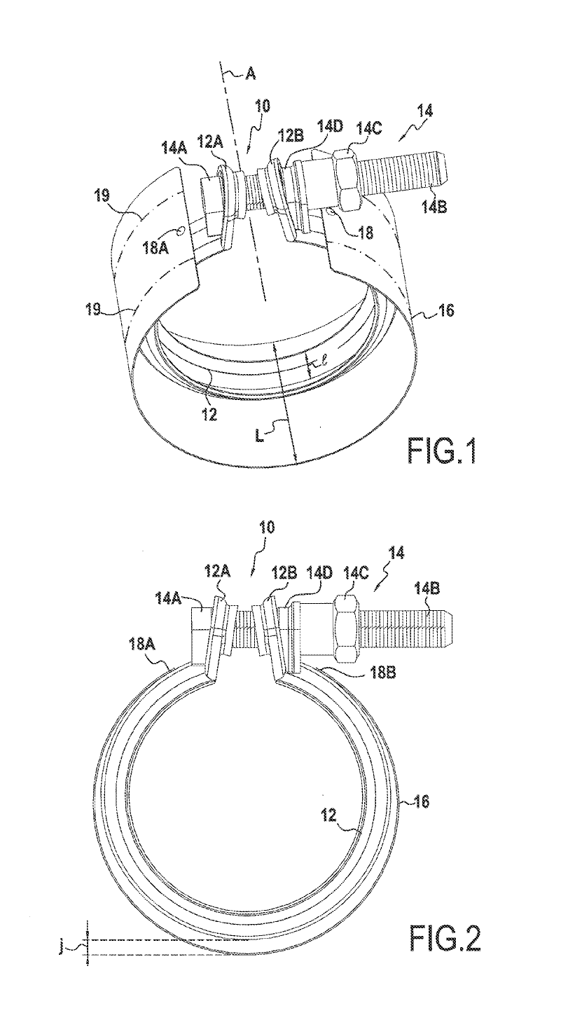

FIG. 1 is a perspective view of a first embodiment of a clamping device of the invention;

FIG. 2 is a side view of the device of FIG. 1;

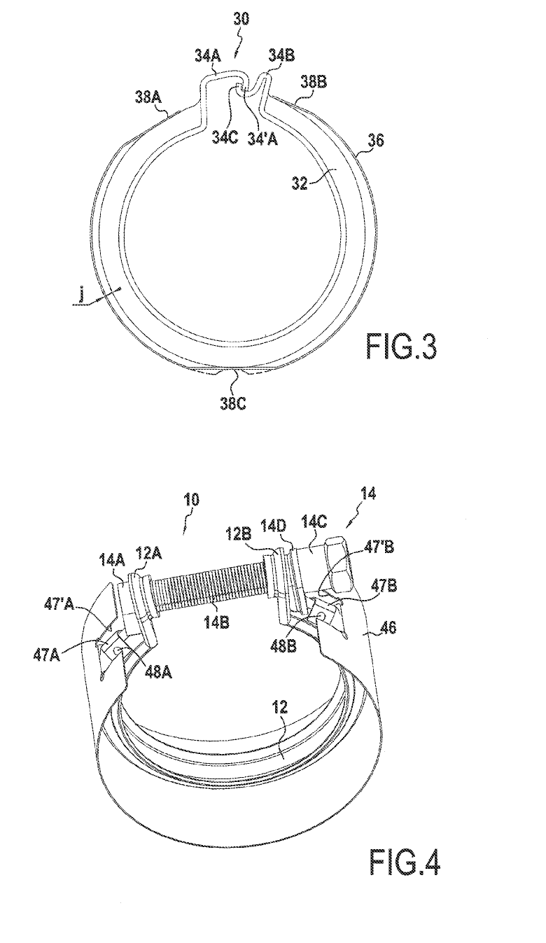

FIG. 3 is also a side view, showing a variant embodiment;

FIG. 4 is a perspective view, showing another variant;

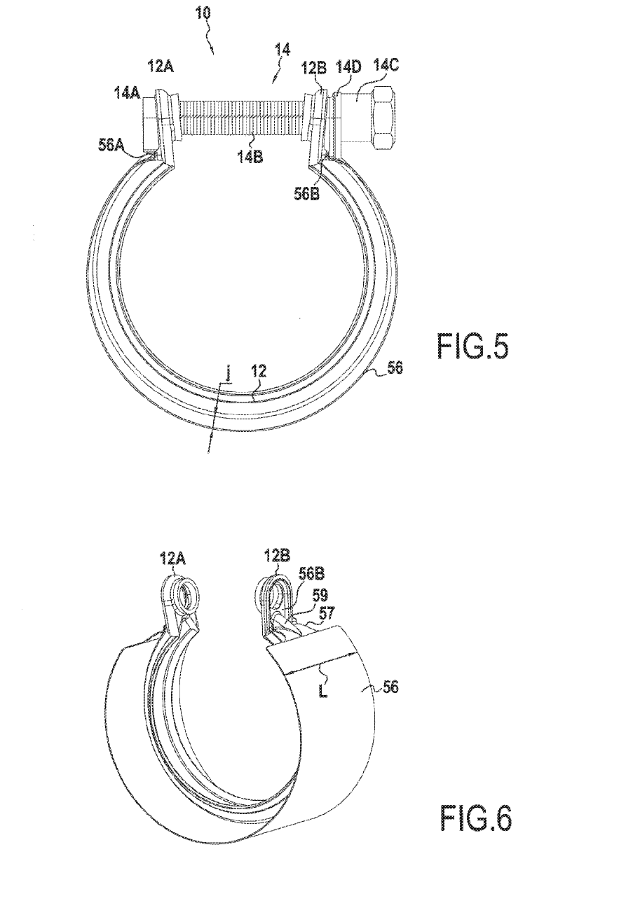

FIG. 5 is a side view, showing yet another variant;

FIG. 6 shows the same variant as FIG. 5, without the tightening bolt for tightening the collar, for ease of understanding;

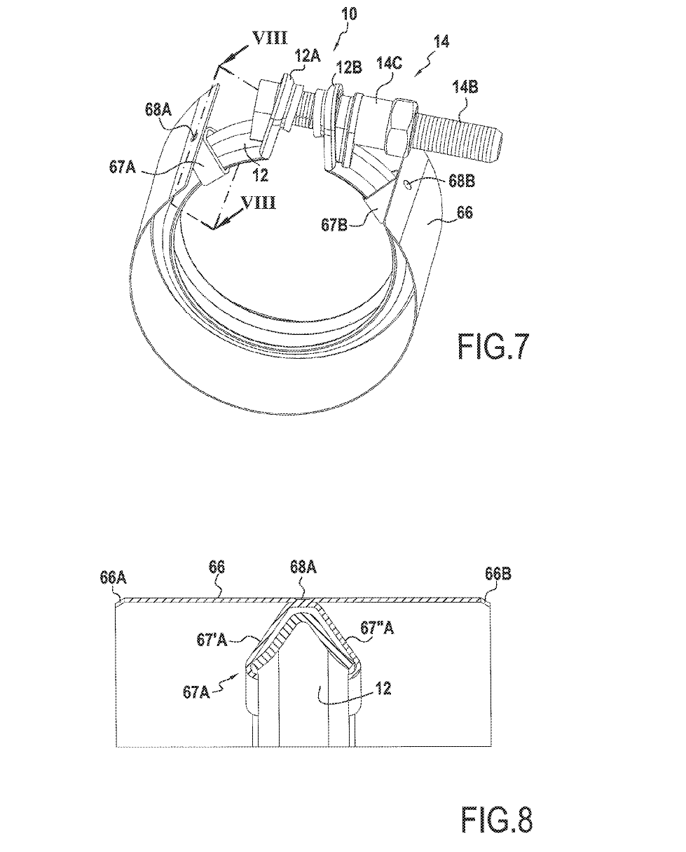

FIG. 7 is a perspective view, showing another variant of the clamping device;

FIG. 8 is a section view on plane VIII-VIII of FIG. 7;

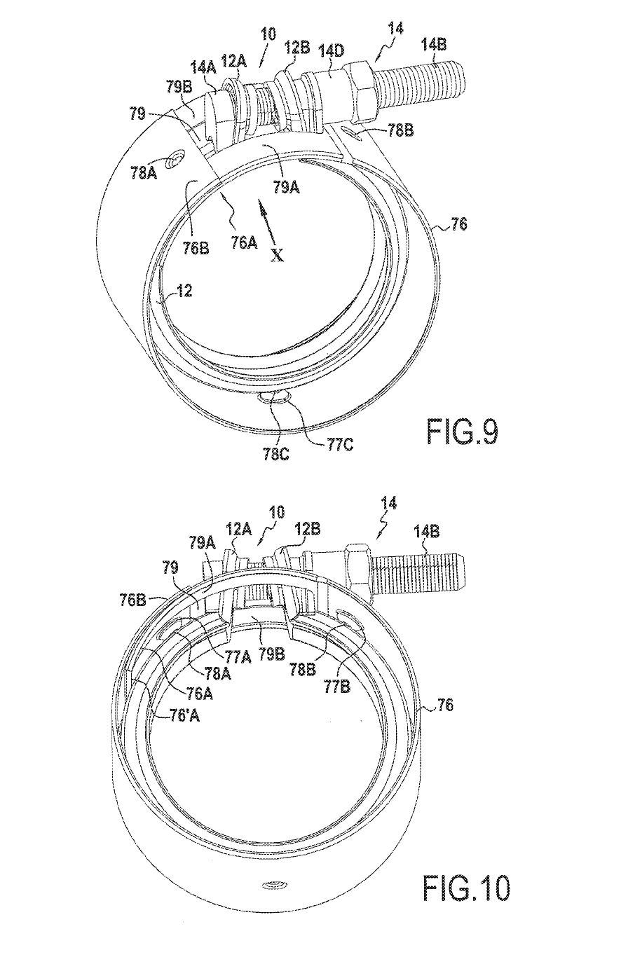

FIG. 9 is a perspective view showing a second embodiment; and

FIG. 10 is a perspective view seen looking along arrow X of FIG. 9.

FIG. 1 shows a clamping device comprising a clamping collar 10, with a belt 12 and clamping lugs that are turned out radially, respectively 12A and 12B. These lugs are provided with through holes through which the shank 14B of a tightening bolt 14 passes, the head 14A of the bolt bearing against lug 12A, and the bolt being suitable for being tightened against lug 12B by a nut 14C.

In addition, in order to straighten out the tightening force and in order to enhance the quality of the clamping, a spacer 14D may be disposed between the nut 14C and the lug 12B.

The device further comprises an outer sleeve 16 that is carried by the collar 10. In FIG. 1, the axis A of the belt is shown and it can be seen that the sleeve 16 extends axially on either side of the belt, while being looped substantially about the same axis A. In this example, the width L of the sleeve 16, as measured along the axis A is at least equal to three times the width l of the belt. When, as in the example shown, the belt is centered axially relative to the sleeve, as a result, on either side of the belt, the sleeve projects by a width at least substantially equal to the width l of the belt. In this example, the width L is about 4 times the width l, so that, on either side of the belt, the sleeve projects by a width substantially equal to 1.5 times the width l. Depending on the uses and on the shapes of the clamped articles, it can be desired not to center the belt axially relative to the sleeve, making provision, conversely, for the sleeve to project to a greater extent on one side of the belt than on the other.

In this example, the device serves to clamp tubes disposed end-to-end, and having their free ends flaring radially outwards. This corresponds to what is described, for example, in Document EP 1 451 498. Thus, the inside periphery of the belt 12 is shaped in recessed manner so as to be capable of receiving the above-mentioned flares. For example, in axial section, the belt may be substantially V-shaped or U-shaped.

The sleeve 16 is carried by the collar 10. In this example, the sleeve 16 is fastened to the belt 12 at two fastening points, respectively 18A and 18B. In particular, this fastening can be by welding or by clinching. The fastening zones 18A and 18B are defined as being fastening points because of their small surface areas. For example, the fastening points may be substantially circular and be of diameter lying in the range 1 millimeter (mm) to 4 mm. Thus, the surface area of each of the fastening points may lie in the range 0.8 square millimeters (mm²) to 20 mm². It preferably lies in the range 2 mm² to 12 mm².

It can be seen in FIG. 2 that clearance j is provided between the outside periphery of the belt 12 and the facing inside periphery of the sleeve 16 over the entire area of the facing surfaces between these two elements, except for the fastening points 18A and 18B. The sleeve may have a nominal diameter that is greater than the initial diameter of the belt, its radius of curvature being smaller in the zones of the fastening points 18A and 18B so as to make the fastening possible. The clearance j is preserved when the collar is tightened, as shown in FIGS. 1 and 2.

The variant shown in FIG. 3 is described below. In this variant, the device comprises a clamping collar 30 and a sleeve 36 carried by said collar. The collar 30 is analogous to the collar 10 of FIG. 1, except as regards its tightening means. It has a belt 32 that is analogous to the belt 12 of the collar 10, but its tightening means comprise a hook-shaped first lug 34A formed at a first end of the belt, and a second lug 34B in the form of a turned-out tab and formed at the opposite end. For the fastening, the free edge 34′A of the hook comes to latch behind the lug 34B. FIG. 3 shows the collar in the pre-latching state, in which the free edge 34′A of the hook is latched behind a turned-out tab 34C situated in front of the lug 34B. The collar is thus closed but not tightened.

The sleeve 36 is fastened to the belt 32. In this example, this fastening is performed at three fastening zones, respectively 38A, 38B, and 38C. The fastening zones 38A and 38B are respectively close to the hook 34A and close to the lug 34B. The fastening zone 38C is substantially diametrically opposite from the free ends that carry the lug and the hook. As in the example of the preceding figure, clearance j is provided between the sleeve and the belt, except in the fastening zones. The fastening zones are fastening points, of surface area analogous to what is indicated above with reference to FIG. 1.

In this example, in order to preserve the clearance j, the fastening zones are formed on flats of the sleeve 36. As indicated in dashed lines in the region of the zone 38C, it is possible to replace these flats with inwardly curved zones, in such a manner as to increase the clearance j in the vicinity of the fastening zone.

FIG. 4 shows a variant embodiment that uses the same collar 10 (shown in the non-tightened state in this example) as the collar shown in FIG. 1. However, the sleeve 46 is slightly different from the sleeve 16 of FIG. 1. The fastening zones are formed in tongues, respectively 47A and 47B, that are cut out from the sleeve and that are deformed in such a manner as to come to match the shape of the outside periphery of the belt 12. Thus, in the example shown, the respective ends of the sleeve 46 are provided with cutouts, respectively 47′A and 47′B, from which the tongues 47A and 47B are thus formed. The tongues are deformed to take the shape of V-shaped or U-shaped bridges having their branches pressed against the branches of the outside periphery of the belt 12. Each of the branches of the bridge-shaped tongues is thus fastened to the belt, e.g. by a spot weld or by clinching, as indicated respectively by the references 48A and 48B on those of the branches that are visible in FIG. 4. The cut-out and folded tongues thus act as fastening tabs, via which the sleeve is fastened to the collar or, as in this example, to the belt.

FIG. 5 shows another variant embodiment, in which the sleeve is also fastened to the collar by fastening tabs. In the example shown, the collar 10 (shown in the non-tightened state in this example) is analogous to the collar shown in FIG. 1. The sleeve 56 is generally analogous to the sleeve 16 and it can be seen that it is carried by the collar with clearance j relative to the belt. However, the sleeve 56 differs from the sleeve 16 in that it is fastened to the collar via fastening tabs, respectively 56A and 56B that co-operate with at least one of the elements constituted by the tightening lugs 12A and 12B, and by the tightening means (bolt 14) of the collar.

As can be seen more clearly in FIG. 6, the ends of the sleeve are folded back radially to have fastening tabs, thus disposed against the rear faces of the clamping lugs 12A and 12B. In this example, as can be seen for tab 56B in FIG. 6, these fastening tabs are stamped to match the inside outline of the lugs 12A and 12B. In addition, the fastening tabs are formed in tongues 57 of width that, naturally, is less than the width L of the sleeve, in such a manner that the width of the fastening tabs 56A and 56B corresponds to the width of the tightening lugs 12A and 12B. In order to stiffen the fastening tabs 56A and 5B, each of these tongues 57 has a stiffener rib 59 in its fold zone, the fold zone being the zone in which a tongue 57 is turned out to form the fastening tab 56A or 56B proper. When the collar is tightened, the fastening tabs 56A and 56B are clamped between the lugs 12A, 12B and the head 14A of the bolt 14, or the nut/the spacer 14C/14D.

FIGS. 7 and 8 show another mode of fastening the sleeve to the collar. In FIG. 7, the collar (shown here in the tightened state) is also analogous to the collar 10 of FIG. 1. The sleeve 66 is analogous to the above-described sleeve, except as regards the mode of fastening it to the collar. In FIGS. 7 and 8, it can be seen that, projecting from its inside periphery, the sleeve 66 carries clipping tabs, respectively 67A and 67B that are merely clipped onto the belt 12 of the collar. As can be better understood in FIG. 8, the clipping tabs are V-shaped, the tip of which V-shape is fastened to the sleeve at 68A or 68B, e.g. by welding or clinching. With reference to FIG. 8, it can be seen that the free ends of the branches 67′A and 67″A of the clipping tab 67A are curved back to come to clip onto the inside free edge of the belt 12. The clipping tabs, like the sleeve and the belt, are made of metal, and can move apart resiliently so as to enable the clipping to take place, i.e. so as to enable them to clip onto belt 12 by returning resiliently. In the example shown, the clipping tabs 67A and 67B are shown at the free ends of the sleeve, in the vicinities of respective ones of the tightening lugs 12A and 12B of the collar. Naturally, more clipping tabs may be provided, e.g. a third clipping tab substantially diametrically opposite from the tightening lugs. In a variant, it is possible to provide the sleeve with clipping tabs that co-operate with the tightening lugs, or indeed with the bolt 14, in particular with the head thereof, and, respectively with its shank or with its nut.

The clipping tabs may be made of the same material as the sleeve and, in particular of the same strip metal or of an analogous strip metal. However, insofar as the clipping tabs are separate and mounted on the sleeve, it is possible, conversely, to choose to make them of a material that is different from the materials of the sleeve, in particular of a material that is of higher strength, and thus specifically adapted to accommodate the clipping stresses. In particular, the clipping tabs may be made of a strip metal that is thicker or that has better elastic properties. In alternative or additional manner, the clipping tabs may be made stronger by appropriate work-hardening.

In the figures that are described above, the free ends of the sleeve are situated on either side of the tightening means. In other words, the sleeve is interrupted in the region of the tightening means and thus does not offer continuous protection.

With reference to FIGS. 9 and 10, a second embodiment is described below that substantially avoids this interruption. In FIGS. 9 and 10, the clamping device comprises the collar 10 of FIG. 1 (shown in the tightened state in this example). The sleeve 76 is carried by the collar by being, in this example, welded or clinched to the belt 12 at three fastening zones, respectively 78A, 78B, and 78C. The sleeve 76 has a window 79 through and beyond which the tightening lugs 12A and 12B of the collar project. Thus, on either side of this window, marginal strips, respectively 79A and 79B, remain that are situated on either side of the lugs 12A and 12B of the collar. Thus, on the axial edges occupied by the marginal strips, the sleeve 76 has a closed outline. In this example, the window 79 is formed at an end 76A of the sleeve 76 that radially overlaps the other end 76B of the sleeve. During the tightening, these two ends can slide one relative to the other so as to enable the diameter of the sleeve 76 to be reduced, so as to accompany the reduction in the diameter of the belt 12.

The first end 76B of the sleeve is situated in the vicinity of the first tightening lug 12A, and its second end 76A is the end that is provided with the window 79 and that has its free end 76′A co-operating with the first end so as to close the outline of the sleeve.

In this example, the free end 76′A of the end 76A of the sleeve is in the form of a bridge that closes the window 79 over said free end. This prevents the marginal strips 79A and 79B from tending to move apart in the axial direction. However, it is possible to make provision for the marginal strips to be present without having such a bridge.

As is indicated, the sleeve is fastened to the belt of the collar at a plurality of fastening zones, respectively 78A, 78B, and 78C. As can be seen better in FIG. 10, one of these fastening zones, namely zone 78A, is situated inside the window 79. In order to facilitate establishing clearance between the outside periphery of the belt 12 and the inside periphery of the sleeve 76, the fastening zones are advantageously formed in projections, respectively 77A, 77B, and 77C that project from the inside face of the sleeve and that co-operate with the belt. On the outside, said projections form recessed dishes, at the bottom of which the fastening zones are formed. On the inside, the above-mentioned projections form spacers between the outside periphery of the belt 12 and the inside periphery of the sleeve 76. Naturally, such projections are fully compatible with the embodiment shown in the preceding figures, in particular with the variants shown in FIGS. 1 to 3. It is also possible to provide such projections that merely act as spacers and/or that participate in the fastening, with the embodiments shown in FIGS. 5 to 8. In addition, the sleeve 76 of FIGS. 9 and 10 is provided with three projections, respectively 77A, 77B, and 77C. However, it is possible to provide a different number of projections, there preferably being at least two projections.

The device of the invention, in particular the belt of the collar and the sleeve, is preferably made of metal. The sleeve is made in such a manner as to form a heat screen, by limiting the transmission of heat between the articles interconnected and clamped by the device and the outside face of the sleeve. In addition, the sleeve is chosen in such a manner as not to hinder the tightening. In particular, the sleeve may be made from thin strip metal that bends significantly more readily than the belt of the collar. For example, the thickness of the sleeve, as measured radially, may lie approximately in the range 0.2 mm to 0.5 mm for stainless steel and approximately in the range 0.4 mm to 1 mm for other materials such as aluminum or aluminized steel.

For example, the sleeve may be made of stainless steel, or else of aluminized steel. In order to reflect heat better towards the inside, it may be shiny at least on its inside surface.

The sleeve does not contribute in any way to the clamping, but, as indicated above, it should not hinder the clamping. Insofar as it is not subjected to any particular forces, and insofar as, in general, it is desired to limit the weight of the clamping device, it is advantageous to choose the sleeve to be of thickness that is as thin as possible. If this thickness makes the sleeve too readily deformable radially, it may be desired to equip it with stiffener means. For example, such stiffener means may be constituted by one or more peripheral ribs 19 projecting from the inside face and/or from the outside face of the sleeve, as indicated in chain-dotted lines in FIG. 1. The term “peripheral rib” means a rib that extends perpendicularly to the axis A of the collar when the sleeve is in place on the collar, so that said rib extends in the direction of the length of the strip from which said sleeve is formed.

In addition, it is also possible, as shown in FIG. 8, to make provision for the longitudinal edges of the sleeve (edges extending along the length of said sleeve, i.e. perpendicularly to the axis A of the device) to be beveled. Thus, in FIG. 8, it can be seen that the edges 66A and 66B of the sleeve are folded back inwards to a small extent in the manner of bevels. This inward folding makes it possible to increase the rigidity of the sleeve so as to prevent it from deforming too readily and, at the same time, so as to limit the sharpness of the edges.

Although the invention can apply to collars having flat belts, it is advantageous in collars having belts provided with inside recesses as in the figure. The sleeve can then be carried by the collar while being naturally at some distance from the articles interconnected by the device. However, as mentioned above, projections forming spacers can contribute to holding the sleeve at some distance from the belt. Such projections then also contribute to holding the sleeve at some distance from the articles interconnected by the device.

Finally, it should be noted that the device of the invention can include pre-fitting and sealing means, e.g. of the type described in Document EP 1 451 498.

In the figures, a sleeve is shown that is generally cylindrical, the cylinder having a circular or substantially circular base, and that is of length (as measured along the axis) that is substantially constant. However, in reality, the sleeve may be shaped to be adapted to match the shape of the parts interconnected by the device and to facilitate its heat screen function. In particular, the sleeve may be out-of-round or provided with a bend, or indeed have indentations, e.g. indentations in its offset edges. Since the sleeve does not take part in the clamping force, a large amount of freedom is allowed as regards its shape, thereby enabling it to be adapted as well as possible to accommodate the constraints of its environment. Since it is of thin thickness, the sleeve is relatively flexible, and its shape can even be adapted in-situ.

1. A clamping device comprising a clamping collar having a belt suitable for being tightened and an outer sleeve carried by the collar while being disposed around the belt, said sleeve extending axially on both sides of the belt.

2. A device according to claim 1, wherein clearance exists between an outside periphery of the belt and the inside periphery of the sleeve.

3. A device according to claim 1, wherein a width of the sleeve, as measured along the axis of the belt, is at least equal to three times a width of the belt.

4. A device according to claim 1, wherein the sleeve is fastened to the collar at at least two spaced-apart fastening zones.

5. A device according to claim 1, wherein the sleeve is provided with projections, on a inside face of the sleeve, said projections co-operating with the belt.

6. A device according to claim 5, wherein at least some of the projections serve as fastening zones.

7. A device according to claim 1, wherein the sleeve is fastened to the belt by welding or by clinching.

8. A device according to claim 1, wherein the sleeve has fastening tabs suitable for co-operating with the collar.

9. A device according to claim 1, wherein the sleeve co-operates with the belt by clipping, snap-fitting or latching.

10. A device according to claim 1, the collar having tightening lugs that are suitable for being brought towards each other for tightening the collar, the sleeve being carried by the collar via at least one of the tightening lugs.

11. A device according to claim 1, wherein the belt is provided with tightening lugs projecting radially relative to the belt, and the sleeve is provided with a window through and beyond which the tightening lugs project.

12. A device according to claim 11, wherein the sleeve has a first end situated in the vicinity of the first tightening lug and a second end that is provided with the window and that has a free end co-operating with the first end.

13. A device according to claim 1, the collar having a tightening screw and a tightening nut, the sleeve being carried by the collar via at least one of the tightening screw and the tightening nut.
